(19) United States
(12) Patent Application Publication
(10) Pub. No.: US 2014/0022391 A1
(43) Pub. Date: Jan. 23, 2014

(54) SYSTEM AND METHOD FOR ENABLING CONTROL OF PTZ CAMERAS

(71) Applicant: Saankhya Labs Private Limited, Bangalore (IN)

(72) Inventors: Parag Naik, Bangalore (IN); Vishwakumara Kayargadde, Bangalore (IN); Vivek Kimbahune, Bangalore (IN); Abdul Aziz Abdul Gafoor, Bangalore (IN); Sunil Hosur Ramesh, Bangalore (IN); Subramanian Harish Krishnan, Bangalore (IN)

(21) Appl. No.: 13/946,130

(22) Filed: Jul. 19, 2013

(30) Foreign Application Priority Data
Jul. 19, 2012 (IN) 2917/CHE/2012

(51) Int. Cl. H04N 7/18

(52) U.S. Cl. CPC H04N 7/181
USPC 348/159

(57) ABSTRACT

A system for controlling at least one camera by enabling a forward channel and a reverse channel is provided. The system includes (i) one or more cameras, (ii) a CMRS that obtains audio information, and video information from the cameras via a coaxial cable or over air. A camera control unit multiplexes PTZ information associated with the one or more cameras and generates a data packet. A modulator modulates the data packet to obtain a modulated data packet which is up converted to a desired RF frequency. A tuner receives the desired RF frequency through the coaxial cable or air, and down converts the RF frequency to obtain the modulated data packet. A demodulator demodulates the modulated data packet to obtain the data packet. A processor de-multiplexes the data packet to obtain the PTZ information that includes a command for at least one of panning, tilting, and zooming a camera.

### BACKGROUND

1. Technical Field

The embodiments herein generally relate to controlling cameras, and, more particularly, to a system and method for enabling control of PTZ cameras.

2. Description of the Related Art

Surveillance systems use analog cameras, digital cameras or digital cameras supporting IP connectivity (popularly known as ‘IP cameras’) for monitoring behavior, activities, or other changing information, usually of people & materials for the purpose of influencing, managing, directing, or protecting. The surveillance solutions are broadly classified based on the i) type of camera (analog, digital, IP, etc.), (ii) transmission methods (analog TV modulation, IP, etc.), iii) transmission medium (coaxial cable, Ethernet cable, CAT5 or CAT6, etc.), and iv) a control, monitor and record systems (CMRS) (analog, IP or digital, etc.).

Analog surveillance systems typically use analog cameras and transmit video information in any one of the analog TV standards (PAL/NTSC/SECAM) over coaxial cables. The digital surveillance systems typically use digital cameras or IP Cameras and transmit the video information over Ethernet network cables. Quality of video provided by the digital surveillance systems is substantially superior when compared to the quality of video provided by the analog surveillance systems. To migrate from an existing analog surveillance system to a digital surveillance system the current solutions require i) replacement of analog cameras with digital cameras or IP cameras, and ii) replacing the coaxial cable with Ethernet Cable—CAT5 or CAT6. While replacing the cameras are easy, re-wiring the entire premises with CAT5 or CAT6 Ethernet cables leads to a complete overhaul of the cabling. This is extremely expensive and often not feasible. Therefore, a system that supports Digital Surveillance over coaxial cable is highly desirable.

Many surveillance cameras also provide functionality to control the Pan, Tilt and Zoom (PTZ) commands specific to the cameras. The PTZ commands for each camera are sent from the Control, Monitor & recording system. These commands are sent either over IP or over a dedicated PTZ interface such as RS485. An IP Surveillance system does not require separate cabling for PTZ control, whereas other surveillance systems require a dedicated cable to each camera from the control, monitor and record system to receive PTZ commands. Having a separate cable for reverse channel (to send PTZ commands) adds further to the cost of the solution. Moreover, in cases where it is not feasible to lay cables for Surveillance systems, deployment of systems that support secure wireless transmission of video and reception of PTZ commands becomes a huge challenge.

FIG. 1 illustrates a block diagram of a typical surveillance system 100 deployment. The surveillance system 100 includes one or more cameras 102A-N, a control, monitor, and recoding system (CMRS) 104, and a display device 106. The deployment requires a cabling infrastructure to carry video and an optional reverse channel to send one or more specific commands to the one or more cameras 102A-N. The typical commands to the one or more cameras are a pan command, a tilt command, and a zoom command. These commands are also referred as PTZ commands.

The reverse path from the CMRS 104 to the one or more cameras 102A-N needs an additional cable which is expensive and also might not be present in some systems including home surveillance systems. In scenarios, where remote monitoring is carried out using cameras connected to the internet through a fixed modem via cables, placing the cameras away from the fixed modem is a challenge. This limitation can be addressed through Wi-Fi enabled IP Cameras. However, the distance, interference and data security issues limit its proliferation.

In many countries, there are regions that do not have adequate broadband access, but have good terrestrial TV infrastructure in place. With freeing of TV white space, the spectrum can be utilized for providing broadband access to these regions.

### SUMMARY

In view of the foregoing, an embodiment herein provides a system for controlling at least one camera by enabling a reverse channel based on a modulation scheme. The system includes one or more cameras, each of the one or more cameras having an identifier, a control, monitor, and record system (CMRS) that includes a camera control unit. The camera control unit multiplexes a pan-tilt-zoom (PTZ) information associated with at least one of the one or more plurality of cameras and generates at least one data packet. The PTZ information includes (a) one or more camera identifiers (IDs), and (b) one or more commands that are specific to the at least one of the one or more cameras. A modulator modulates the at least one data packet to obtain a modulated data packet. The modulated data packet is up converted to a desired RF frequency. A tuner is connected to the modulator. The tuner down converts the desired RF frequency to obtain the modulated data packet. The tuner receives the desired RF frequency from the modulator over a coaxial cable or over air. A demodulator is connected to the tuner. The demodulator demodulates the modulated data packet to obtain the at least one data packet. A processor is connected to the demodulator and the one or more cameras. The processors de-multiplexes the at least one data packet to obtain the PTZ information. The PTZ information includes the one or more commands. The processor communicates a command from to at least one camera for panning, tilting, and zooming the at least one camera.

A forward channel is enabled for communicating at least one of: an audio information, and a video information from the one or more cameras to the CMRS via said coaxial cable or over air. The modulated data packet is up converted to the desired RF frequency based on a pre-set modulation standard.

In another aspect, a system for controlling at least one camera by enabling a forward channel and a reverse channel is provided. The system includes one or more cameras, each of the one or more cameras having an identifier, a control, monitor, and record system (CMRS) that includes a camera control unit. The CMRS obtains at least one of: an audio information, and a video information from the one or more cameras via a coaxial cable or over air. The camera control unit multiplexes a pan-tilt-zoom (PTZ) information associated with the one or more cameras and generates at least one data packet. The PTZ information includes (a) one or more camera identifiers (IDs), and (b) one or more commands that are specific to the one or more cameras. A modulator modulates the at least one data packet to obtain a modulated data packet. The modulated data packet is up converted to a desired RF frequency. A tuner is connected to the modulator. The tuner down converts the desired RF frequency to obtain the modulated data packet. The tuner receives the desired RF frequency from the modulator over a coaxial cable or over air. A demodulator is connected to the tuner. The demodulator demodulates the modulated data packet to obtain the at least one data packet. A processor is connected to the demodulator and the one or more cameras. The processors de-multiplexes the at least one data packet to obtain the PTZ information. The PTZ information includes the one or more commands The processor communicates a command from to at least one camera for panning, tilting, and zooming the at least one camera. The modulated data packet is up converted to the desired RF frequency based on a pre-set modulation standard.

In yet another aspect, a method for controlling at least one camera by enabling a reverse channel is provided. The method includes (i) multiplexing a pan-tilt-zoom (PTZ) information associated with one or more cameras and generating at least one data packet, (ii) modulating, by a modulator, the at least one data packet to obtain a modulated data packet. The PTZ information includes (a) one or more camera identifiers (IDs), and (b) one or more commands that are specific to the one or more cameras. The modulated data packet is up converted to a desired RF frequency. The method further includes (iii) down converting, by a tuner, the desired RF frequency to obtain the modulated data packet. The tuner receives the desired RF frequency from the modulator over a coaxial cable or over air. The method further includes (iv) demodulating, by a demodulator, the modulated data packet to obtain the at least one data packet, (v) de-multiplexing the at least one data packet to obtain the PTZ information. The PTZ information includes the one or more commands A command from the one or more commands is communicated to at least one camera. The command include at least one of panning, tilting, and zooming the at least one camera.

A forward channel may be enabled by communicating at least one of: an audio information, and a video information from the one or more cameras to the CMRS via the coaxial cable or over air. The modulated data packet is up converted to the desired RF frequency based on a pre-set modulation standard.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a block diagram of a typical surveillance system deployment.

FIG. 2 is a block diagram illustrating a surveillance network system according to one embodiment of the present disclosure.

FIG. 3 illustrates an exploded view of the RF CAMODs of FIG. 2 according to one embodiment of the present disclosure.

FIG. 4 is a block diagram illustrating an IP-RF module according to one embodiment of the present disclosure.

With reference to FIG. 4, FIG. 5 illustrates a point to point IP link system using the IP-RF module of FIG. 4 according to one embodiment of the present disclosure.

FIG. 6 illustrates an exploded view of a receiver used in accordance with the embodiments herein.

FIG. 7 illustrates a schematic diagram of a computer architecture used in accordance with the embodiments herein.

FIG. 8 is a flow diagram illustrating a method of controlling at least one camera by enabling a reverse channel according to one embodiment of the present disclosure.

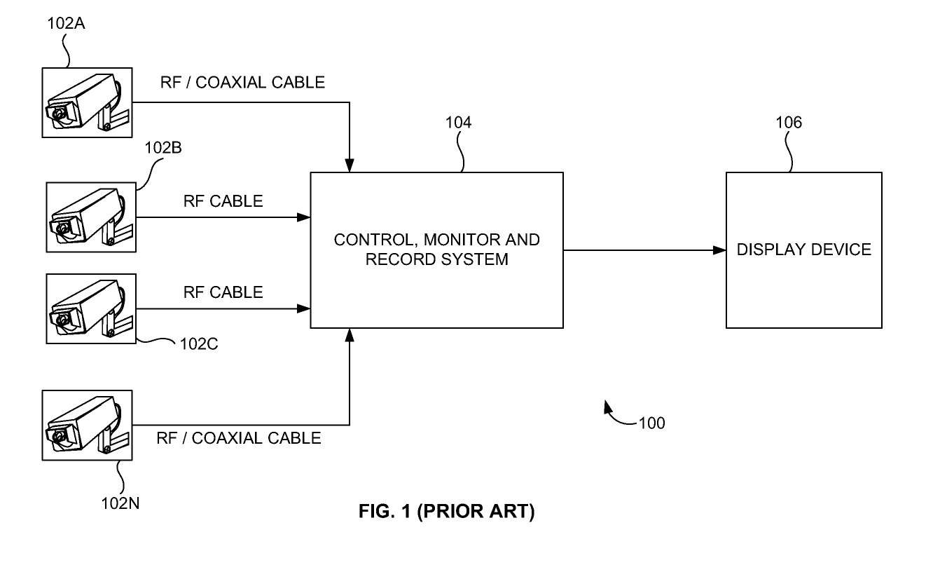

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

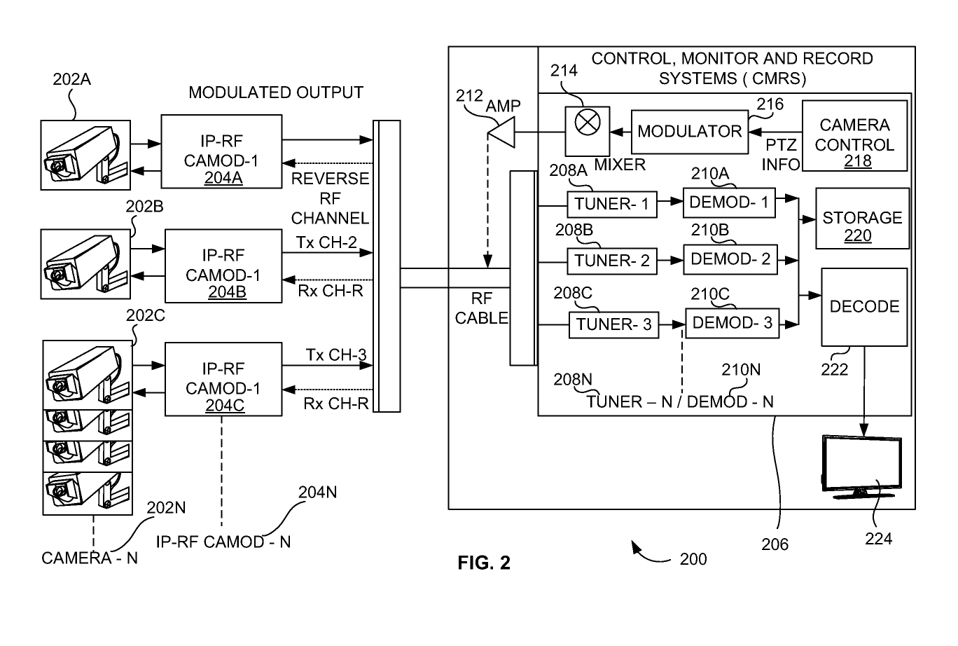

As mentioned, there remains a need for system and method for enabling a reverse channel, and/or a forward channel over the air or via a cable (e.g., a TV coaxial cable) based on a modulation scheme. The reverse channel is a pathway for communicating information for controlling one or more cameras from a control, monitor, and record systems (CMRS) to the one or more cameras. The forward channel is a pathway for communicating information that is captured using one or more cameras from the one or more cameras to the CMRS, usually via TV coaxial cables or Ethernet cables. In one embodiment, information associated with the reverse channel for controlling one or more cameras is communicated to the cameras using one or more cables that are used for the forward channel. In another embodiment, information for controlling the one or more cameras is communicated over air (e.g., television white spectrum). The embodiments herein achieve this by providing a system that implements (i) a reverse path, and/or a forward path for a surveillance system over the air or via a coaxial cable and (ii) a point to point IP link system over the air or via the coaxial cable. The reverse path is enabled by providing (i) a modulator, and (ii) a demodulator. The modulator at a control, monitor, and record system (CMRS) that modulates one or more data packets which include Pan-Tilt-Zoom (PTZ) information to a modulated data packet, and the modulated data packet is up converted to a desired RF frequency. The demodulator that demodulates the modulated data packet that is obtained from a tuner to obtain the one or more data packets. For implementing the reverse path or the point to point IP link system over the air or via a coaxial cable, the link is enabled by transmission and reception of IP packets that are modulated based on the modulation scheme. The outbound IP packets are modulated into a pre-set modulation scheme, and sent over the air or coaxial cable. The modulation scheme may include, but not limited to, Advanced Television Systems Committee (ATSC) standard, a Digital Video Broadcasting-Terrestrial (DVB-T) standard, a Cable standard, an Analog standard, a Digital Multimedia Broadcast-Terrestrial (DMB-T) standard (multi-carrier), an Integrated Services Digital Broadcasting-Terrestrial (ISDB-T) standard, and a Digital Multimedia Broadcast-Terrestrial (DMB-T) standard (single-carrier), and/or satellite standards may be DVB-S standard, ISDB-S standard, IESS standard, etc. Referring now to the drawings, and more particularly to FIGS. 2 through 8, where similar reference characters denote corresponding features consistently throughout the figures, there are shown preferred embodiments.

FIG. 2 is a block diagram illustrating a surveillance network system 200 according to one embodiment of the present disclosure. The surveillance network system 200 includes one or more cameras 202A-N, one or more RF CAMODs (camera modules) 204A-N, and a control, monitor and record Systems (CMRS) 206. The control, monitor and record Systems (CMRS) 206 includes one or more tuners 208A-N, one or more demodulators 210A-N, an amplifier 212, a mixer 214, a modulator 216, a camera control unit 218, a storage unit 220, a decode unit 222, and a display device 224.

The surveillance network system 200 includes a chipset to implement the forward path and the reverse path. In one embodiment, the surveillance network system 200 may also include more than one chipset to implement the forward path and the reverse path. In one embodiment, for enabling an IP packet transport, the chipset may be implemented to perform modulation and demodulation of any broadcasting signals. In one embodiment, for example in the surveillance scenario, the surveillance network system 200 provides the reverse path from the CMRS 206 to the cameras 202A-N using cable infrastructure. Each camera of the one or more cameras 202A-N may include an identifier.

In one embodiment, Pan-Tilt-Zoom (PTZ) information is generated at the CMRS 206. The PTZ information may include a) one or more commands that are specific to the one or more cameras 202A-N, and b) one or more camera identifiers. Each command is specific to a camera includes information for at least one of panning, tilting, and zooming the camera. An example for a PTZ information includes, (i) a) a first camera identifier associated with the camera 202A, and b) a first command for tilting the camera 202A, and (ii) (a) a second camera identifier associated with the ‘camera 202C’, and b) a second command for panning and zooming the camera 202C. The camera control unit 218 (which may be at the CMRS 206) multiplexes the PTZ information associated with at least one camera of the one or more cameras 202A-N to generate one or more data packets. In one embodiment, the data packet is a single transport stream (TS) packet. In one embodiment, if there are not enough such TS packets, null packets may be padded. It is understood that there could be more than one camera control unit 218, and each camera control may multiplex one or more PTZ information, in one example embodiment.

The modulator 216, at the control, monitor and record Systems (CMRS) 206, modulates the one or more data packets to obtain a modulated data packet. In one embodiment, the modulated data packet may include the PTZ information that is generated from the CMRS 206. The modulated data packet is up converted to a desired RF frequency.

In one example embodiment, up conversion of the modulated data packet is performed by a) mixing the modulated data packet with one or more signals (e.g., a reference RF signal which may be a sinusoidal signal, and/or an IF signal, etc.), and b) amplifying an output after mixing the modulated data packet with one or more signals. In one embodiment, the desired RF frequency is communicated to the one or more RF CAMODs 204A-N through a transmission media. Examples of the transmission media include a) a cable (e.g., a coaxial cable) that interconnects the one or more cameras 202A-N and the CMRS 206 at the forward channel, b) over air (e.g., a TV white spectrum). In one embodiment, the modulated data packet is up converted to the desired RF frequency based on a pre-set modulation standard. In one embodiment, the control, monitor and record Systems (CMRS) 206 acts as a rudimentary MAC layer in a networking system. In one embodiment, a combined PTZ information may be broadcasted over fixed or variable channel bandwidths. The RF CAMOD 204A-N demodulates the desired RF frequency that may include the PTZ information which is generated at the control, monitor and record systems (CMRS) 206. The RF CAMODs 204A-N may be either connected to each of the one or more cameras 202A-N as a separate unit, in one example embodiment. Each of the RF CAMODs 204A-N may be integrated within each of the one or more cameras 202A-N, in another example embodiment.

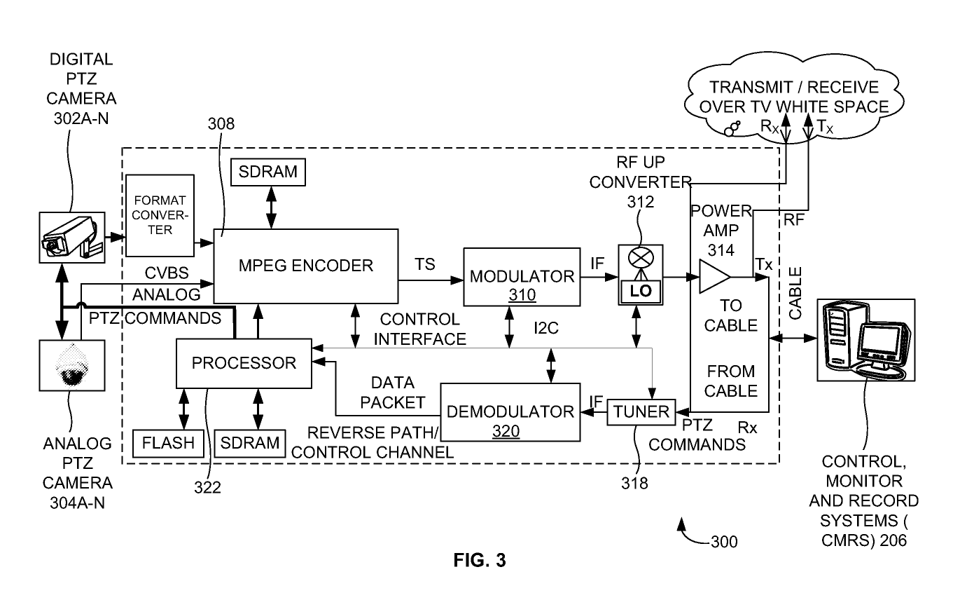

FIG. 3 illustrates an exploded view of the RF CAMODs 204A-N of FIG. 2 according to one embodiment of the present disclosure. The RF CAMOD 204A-N includes a MPEG encoder 308, a modulator 310, an RF up converter 312, a power amplifier 314, the control, monitor and record Systems (CMRS) 206, a tuner 318, a demodulator 320, and a processor 322. Output from the RF CAMODs 204 A-N is communicated to at least one camera of the one or more cameras 202A-N. In one embodiment, the one or more cameras 202A-N may be one or more digital PTZ cameras 302A-N as shown in the FIG. 3, and/or may be one or more analog PTZ cameras 304A-N as shown in the FIG. 3.

The MPEG encoder 308 encodes video information, and/or audio information from the one or more analog PTZ cameras 304A-N, and/or the one or more digital PTZ cameras 302A-N. The audio, and/or and video output from the one or more digital PTZ cameras 302A-N may be processed by a format converter. The format converter outputs data to the MPEG encoder 308. The modulator 310 receives an output that includes one or more data packets (e.g., a transport stream packet for audio and video information obtained from the one or more analog PTZ cameras 304A-N) from the MPEG encoder 308, and modulates the one or more data packets using a pre-set digital modulation scheme. In one embodiment, the modulator 310 is used to modulate the audio information, and/or the video information which is generated by the digital PTZ cameras 302A-N, and/or the analog PTZ cameras 304A-N.

The tuner 318 receives the desired RF frequency that is generated based on up conversion of modulated data packet from the modulator 216 of FIG. 2 via a cable (e.g., TV coaxial cable), or over the air (e.g., the TV white spectrum). Further, the tuner 318 down converts the desired RF frequency, and generates the modulated data packet which is obtained from the modulator 216. The demodulator 320 demodulates the modulated data packet, and generates the one or more data packets which are obtained from the camera control unit 218. The one or more data packets include PTZ information associated with the one or more cameras 202A-N (e.g., the digital PTZ cameras 302A-N, and/or the analog PTZ cameras 304A-N).

The processor 322 de-multiplexes the one or more data packets from the demodulator 320, and generates the PTZ information which is generated at the CMRS 206. The PTZ information may include a) one or more commands that are specific to the one or more digital PTZ cameras 302A-N, and/or the one or more analog PTZ cameras 304A-N, and b) one or more camera identifiers. The processor 322 may compare a camera identifier from the PTZ information with one or more identifiers associated with the digital PTZ cameras 302A-N, and/or the analog PTZ cameras 304A-N. The processor 322 then communicates a command to a camera (e.g., a digital PTZ camera 302A, or an analog PTZ camera 304A) when the camera identifier from the PTZ information matches with an identifier associated with the camera. The command includes information for at least one of panning, zooming, and tilting the camera. Similarly, each camera identifier from the PTZ information is compared with one or more identifiers associated with the cameras (digital, and/or analog), and identify for which camera which command from the PTZ information has to communicate. In one embodiment, the reverse path can also be used to download software to the one or more digital PTZ cameras 302A-N, and/or the one or more analog PTZ cameras 304A-N, and change one or more parameter settings.

In one embodiment, a transmission medium (e.g., cable or air) that is used for enabling the reverse channel (e.g., communicating the desired RF frequency to the tuner 318) is used for enabling a forward channel. The forward channel is enabled when at least one of an audio information, and/or a video information from the one or more cameras 202A-N is communicated to the CMRS 206. Thus, both the reverse channel and the forward channel are enabled using the same transmission medium.

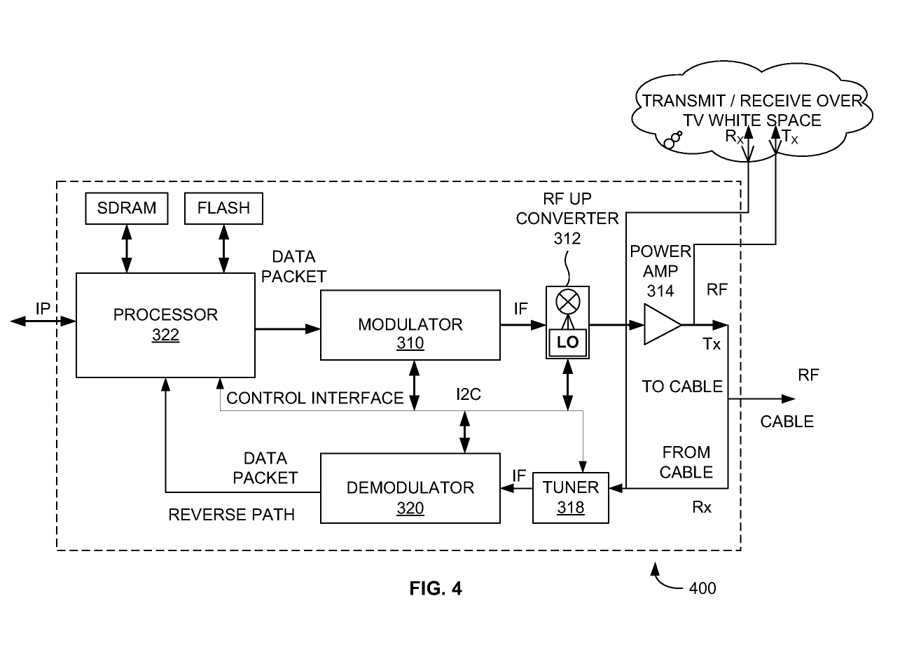

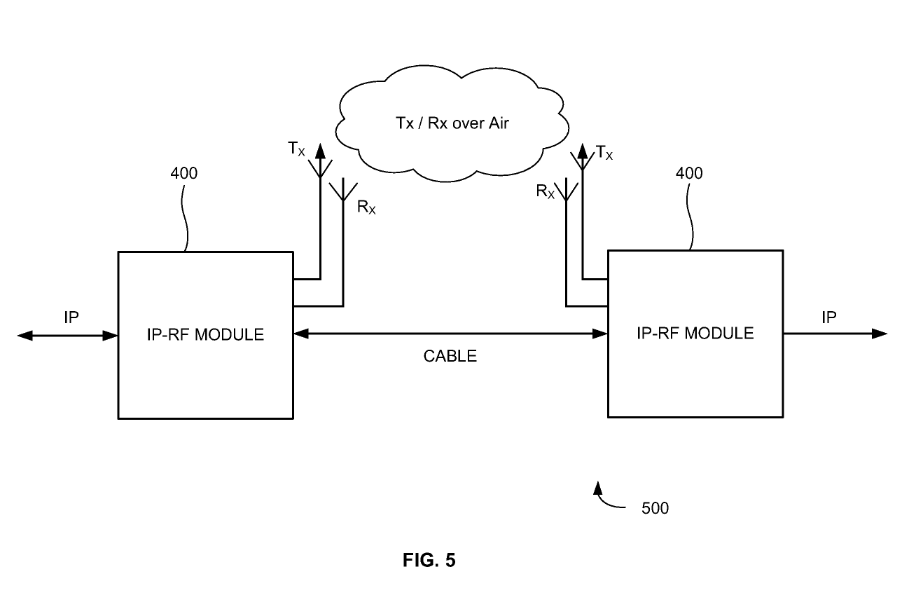

FIG. 4 is a block diagram illustrating an IP-RF module 400 according to one embodiment of the present disclosure. The IP-RF module 400 includes the processor 322 with an IP stack, the modulator 310, the tuner 318, and the demodulator 320. In one embodiment, the IP-RF module 400 includes an input/output interface such as a RJ-45 connector. The processor 322 of FIG. 4 includes an IP stack. As described in the previous embodiments, one or more packet data (e.g., Ethernet packets) from the camera control unit 218 may be modulated into a pre-set modulation scheme by the modulator 310 to obtain a modulated data packet. The modulated data packet is then up converted to a desired RF signal (e.g., using the RF up converter 312 of FIG. 3). The desired RF signal is transmitted over the air or through a cable.

The desired RF signal (to the tuner 318 in FIG. 4) in a pre-set modulated scheme is received over the air or via cable from the control, monitor and record system (CMRS) 206. The tuner 318 tunes the desired RF signal to the modulated data packet. The output of the tuner 318 is demodulated by the demodulator 320 to obtain the one or more data packets in the reverse path. The processor 322 recovers one or more IP packets (e.g., the Ethernet packet) after removing transport stream headers of the incoming one or more data packets.

With reference to FIG. 4, FIG. 5 illustrates a point to point IP link system 500 using the IP-RF module 400 of FIG. 4 according to one embodiment of the present disclosure. The output signals from the two or more IP-RF modules 400 may be transmitted to each other over the air or via the cable. IP Packets from the one or more digital PTZ cameras 302A-N, and/or the one or more analog PTZ cameras 304A-N which include audio, and/or video information are communicated to the modulator 310 as data packets. An output of the modulator 310 (i.e., a modulated data packet) is communicated to the RF up converter 312 to generate a desired RF frequency, which is transmitted over a coaxial cable or over air. At the receiving end (e.g., the CMRS 206), the tuner 318 tunes the desired RF frequency to obtain the modulated data packets. The demodulator 320 demodulates the modulated data packets to obtain the IP packets which are fed to the CMRS 216. The PTZ information from the CMRS 206 is formed as IP packets at the CMRS end. These IP packets are communicated through the modulator 216 at the CMRS end, and are received at the camera end after demodulation by the demodulator 320. It is understood that the above embodiments can be implemented for one or more IP cameras.

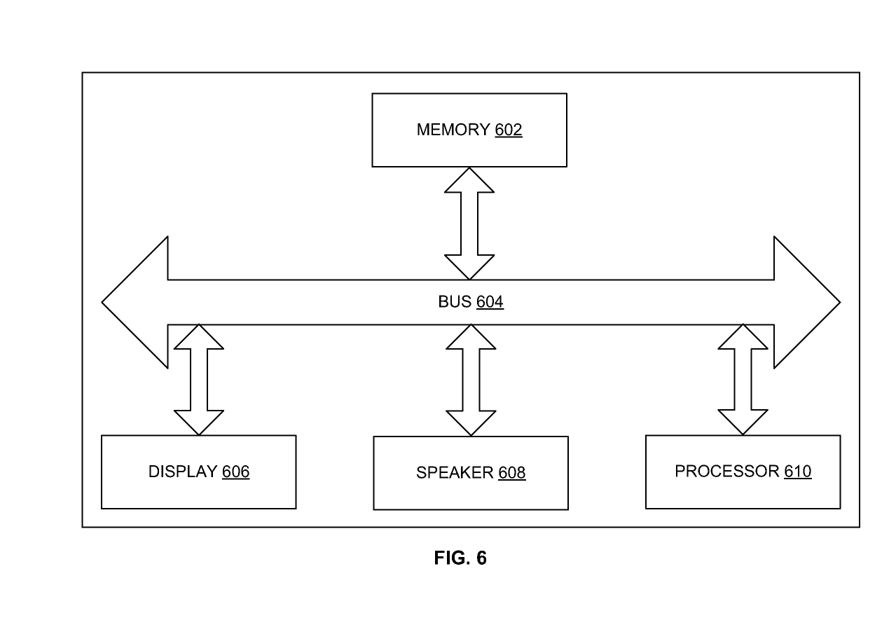

FIG. 6 illustrates an exploded view of a receiver of having an a memory 602 having a set of computer instructions, a bus 604, a display 606, a speaker 608, and a processor 610 capable of processing a set of instructions to perform any one or more of the methodologies herein, according to an embodiment herein. The processor 610 may also enable digital content to be consumed in the form of video for output via one or more displays 606 or audio for output via speaker and/or earphones 608. The processor 610 may also carry out the methods described herein and in accordance with the embodiments herein.

Digital content may also be stored in the memory 602 for future processing or consumption. The memory 602 may also store program specific information and/or service information (PSI/SI), including information about digital content (e.g., the detected information bits) available in the future or stored from the past. A user of the receiver may view this stored information on display 606 and select an item of for viewing, listening, or other uses via input, which may take the form of keypad, scroll, or other input device(s) or combinations thereof. When digital content is selected, the processor 610 may pass information. The content and PSI/SI may be passed among functions within the receiver using the bus 604. The receiver may either be the one or more cameras 202A-N and/or the CMRS 206.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections).

In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of an entirely hardware embodiment, an entirely software embodiment or an embodiment including both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

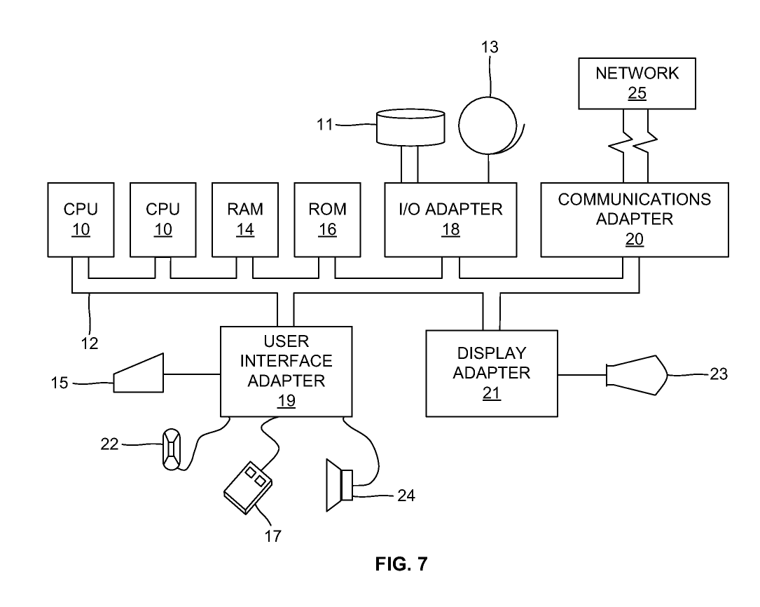

A representative hardware environment for practicing the embodiments herein is depicted in FIG. 7. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

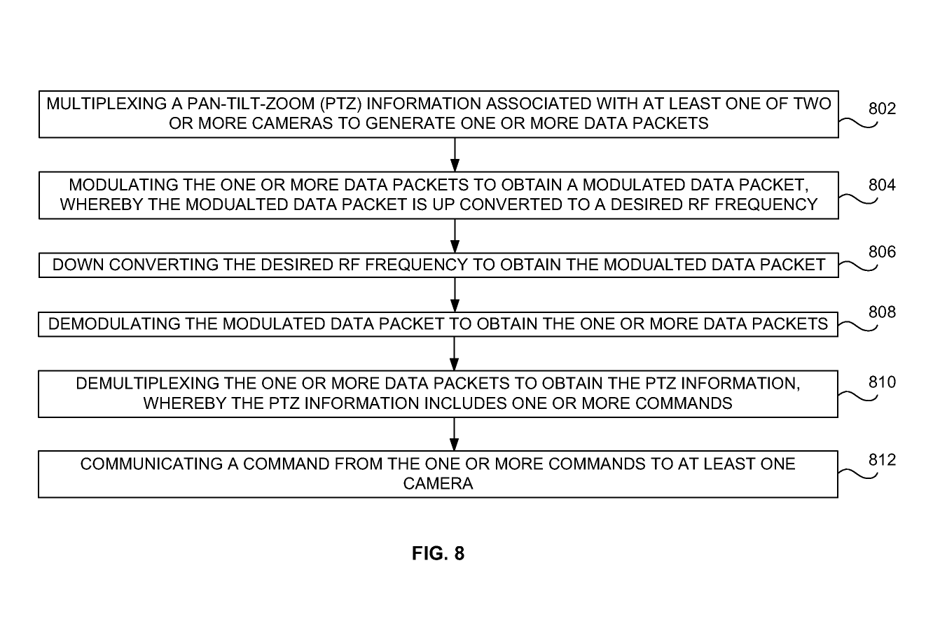

FIG. 8 is a flow diagram illustrating a method of controlling at least one camera by enabling a reverse channel according to one embodiment of the present disclosure. In step 802, a pan-tilt-zoom (PTZ) information associated with at least one of two or more cameras is multiplexed to generate one or more data packets. The PTZ information includes (a) one or more camera identifiers (IDs), and (b) one or more commands that are specific to the at least one of the two or more cameras. In step 804, the one or more data packets are modulated, by a modulator, to obtain a modulated data packet. The modulated data packet is up converted to a desired RF frequency. In step 806, the desired RF frequency is down converted, by a tuner, to obtain the modulated data packet. The tuner receives the desired RF frequency from the modulator over a coaxial cable or over air. In step 808, the modulated data packet is demodulated, by the demodulator, to obtain the one or more packets. In step 810, the one or more data packets are de-multiplexed to obtain the PTZ information. The PTZ information includes the one or more commands. In step 812, a command from the one or more commands is communicated to at least one camera. The command includes at least of panning, tilting, and zooming the at least one camera.

The above system and method may be enabled using a single IC to perform modulation. It is possible that TV white space standard consortium define standards that implement single chip modems for this implementation.

Further, the above embodiments for enabling a reverse channel, and/or a forward channel based on a modulation scheme may also be performed by using a Field-programmable gate array (FPGA), and data over cable service interface specification (DOCSIS) standards. Additionally, the above embodiments for enabling a reverse channel, and/or a forward channel may be implemented using proprietary modulation techniques or any other one or more modulation schemes (e.g., FM modulation standards, DAB standards, Wi-Fi standards). Both the forward channel and the reverse channel can be enabled using the same transmission medium (e.g., a cable or over air). Therefore, a typical approach of having an additional cable for enabling the reverse channel is completely eliminated. Thus, there is a drastically reduction in deployment costs for implementing the reverse channel. Embodiment mentioned herein can enable a range of wireless TV cameras in surveillance markets, and may allow extending IP networks to legacy cable TV and terrestrial TV networks.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system for controlling at least one camera by enabling a reverse channel, said system comprising:
(i) a plurality of cameras, wherein each of said plurality of cameras comprises an identifier;
(ii) a control, monitor, and record system (CMRS) comprising a camera control unit, wherein said camera control unit multiplexes a pan-tilt-zoom (PTZ) information associated with at least one of said plurality of cameras to generate at least one data packet, wherein said PTZ information comprises (a) a plurality of camera identifiers (IDs), and (b) a plurality of commands that are specific to said at least one of said plurality of cameras;
(iii) a modulator that modulates said at least one data packet to obtain a modulated data packet, wherein said modulated data packet is up converted to a desired RF frequency;
(iv) a tuner that down converts said desired RF frequency to obtain said modulated data packet, wherein said tuner receives said desired RF frequency from said modulator over a coaxial cable or over air;
(v) a demodulator that demodulates said modulated data packet to obtain said at least one data packet; and
(vi) a processor that:
(a) de-multiplexes said at least one data packet to obtain said PTZ information, wherein said PTZ information comprises said plurality of commands, and (b) communicates a command from said plurality of commands to at least one camera, wherein said command comprises at least one of panning, tilting, and zooming said at least one camera.

2. The system of claim 1, wherein a forward channel is enabled for communicating at least one of: an audio information, and a video information from said plurality of cameras to said CMRS via said coaxial cable or over air.

3. The system of claim 1, wherein said modulated data packet is up converted to said desired RF frequency based on a pre-set modulation standard.

4. A system for controlling at least one camera by enabling a forward channel and a reverse channel, said system comprising:
(i) a plurality of cameras, wherein each of said plurality of cameras comprises an identifier;
(ii) a control, monitor, and record system (CMRS) comprising a camera control unit, wherein said CMRS obtains at least one of: an audio information, and a video information from at least one of said plurality of cameras via a coaxial cable or over air, wherein said camera control unit multiplexes a pan-tilt-zoom (PTZ) information associated with at least one of said plurality of cameras to generate at least one data packet, wherein said PTZ information comprises (a) a plurality of camera identifiers (IDs), and (b) a plurality of commands that are specific to said at least one of said plurality of cameras;
(iii) a modulator that modulates said at least one data packet to obtain a modulated data packet, wherein said modulated data packet is up converted to a desired RF frequency;
(iv) a tuner that down converts said desired RF frequency to obtain said modulated data packet, wherein said tuner receives said desired RF frequency from said modulator over said coaxial cable or over air;
(v) a demodulator that demodulates said modulated data packet to obtain said at least one data packet; and
(vi) a processor that:
(a) de-multiplexes said at least one data packet to obtain said PTZ information, wherein said PTZ information comprises said plurality of commands, and (b) communicates a command from said plurality of commands to at least one camera, wherein said command comprises at least one of panning, tilting, and zooming said at least one camera.

5. The system of claim 4, wherein said modulated data packet is up converted to said desired RF frequency based on a pre-set modulation standard.

6. A method for controlling at least one camera by enabling a reverse channel, said method comprising:
(i) multiplexing a pan-tilt-zoom (PTZ) information associated with at least one of a plurality of cameras to generate at least one data packet, wherein said PTZ information comprises (a) a plurality of camera identifiers (IDs), and (b) a plurality of commands that are specific to said at least one of said plurality of cameras;
(ii) modulating, by a modulator, said at least one data packet to obtain a modulated data packet, wherein said modulated data packet is up converted to a desired RF frequency;
(iii) down converting, by a tuner, said desired RF frequency to obtain said modulated data packet, wherein said tuner receives said desired RF frequency from said modulator over a coaxial cable or over air;
(iv) demodulating, by a demodulator, said modulated data packet to obtain said at least one data packet;
(v) de-multiplexing said at least one data packet to obtain said PTZ information, wherein said PTZ information comprises said plurality of commands; and
(vi) communicating a command from said plurality of commands to at least one camera, wherein said command comprises at least one of panning, tilting, and zooming said at least one camera.

7. The method of claim 6, further comprising enabling a forward channel by communicating at least one of: an audio information, and a video information from said plurality of cameras to said CMRS via said coaxial cable or over air.

8. The method of claim 6, wherein said modulated data packet is up converted to said desired RF frequency based on a pre-set modulation standard.
